(19) United States
(12) Patent Application Publication
(10) Pub. No.: US 2005/0133354 A1
(43) Pub. Date: Jun. 23, 2005

(54) Handheld blower

(75) Inventors: Mitsunori Watanabe, Shizuoka-ken (JP); Hiroshi Kubota, Shizuoka-ken (JP); Hiroyuki Noda, Shizuoka-ken (JP)

Correspondence Address: MCGINN & GIBB, PLLC, 8321 OLD COURTHOUSE ROAD, SUITE 200, VIENNA, VA, 22182-3817, US

(73) Assignee: Fuji Robin Kabushiki Kaisha, Numazu-shi (JP)

(21) Appl. No.: 11/011,431

(22) Filed: Dec. 15, 2004

(30) Foreign Application Priority Data
Dec. 19, 2003 (JP) JP2003-423187

(51) Int. Cl. H01H 9/06

(52) U.S. Cl. 200/334

(57) ABSTRACT

A handheld blower is provided with an end pipe having a blowing opening at a distal end thereof, the end pipe being coupled to the upper half side of an impeller case and extended in a tangential direction of the impeller. The blower further includes a grip grasped by an operator's fingers to support the blower in a suspended manner, a stop switch provided on an extension line of a widthwise center line of the grip, and a thumb rest extending to a side of the grip from near the stop switch for receiving the operator's thumb. Thus, the handheld blower can prevent accidental stop of the blower, which is caused by an inadvertent touch to the stop switch with the thumb, during use, and enables the operator to keep orienting the end pipe to a desired direction while mitigating the load on the thumb on the grip.

### BACKGROUND OF THE INVENTION

The present invention relates to a handheld blower and more particularly to an operating part of the blower.

The present application claims priority from Japanese Patent Application No. 2003-423187, the disclosure of which is incorporated herein by reference.

A handheld blower as shown, for example, in Japanese Patent Application Laid-Open No. Hei 8-200064 is known as an apparatus for cleaning operation in which scattered lightweight rubbish such as leaves on the ground are collected in one place by blowing.

Referring to FIG. 5 which shows one embodiment of the present invention, a handheld blower generally includes an engine case 2 accommodating an engine which is the power source, an impeller coupled to the output shaft of the engine, a connection pipe 7 attached to the casing 4 of the impeller in a tangential direction thereof, and an end pipe 6 at the other end of the connection pipe 7, with an opening 6A for the blowing operation.

On top of the engine case 2 is a grip 5 for holding the blower 1 in a suspended manner.

The grip 5 includes a throttle lever 5A on the inner side and an engine stop switch 5B on the outer side as shown in FIG. 6.

With an operator's hand grasping the grip 5, the throttle lever 5A is operated with a forefinger TH1, and the stop switch 5B with a thumb TH placed on the upper face of the grip.

The operator's fingers other than the thumb TH are used for grasping the grip 5, while the thumb TH positioned on the upper side of the grip 5 is mainly used for maintaining the end pipe 6 downward. As the thumb TH is positioned farther to the front of the grip than the other fingers, when the operator's wrist is inclined, a force can be applied to incline the grip 5.

However, in the case where the thumb TH on the upper face of the grip 5 is positioned along an extension line of the widthwise center line of the stop switch 5B on the front of the grip 5, depending on the location of the stop switch 5B, particularly when the stop switch 5B is of the type which is slid to the front or back of the grip to stop the blower, there is a danger that the stop switch 5B is accidentally operated against the operator's intention during the operation.

During the operation, the operator needs to keep pressing forward down the grip 5 with the thumb to maintain the end pipe 6 of the blower 1 downward.

In the case where the stop switch 5B is of the type which is slid forward of the grip 5 to stop the blower, it is likely that the thumb TH, which is pressed against the upper face of the grip 5 with some pressure, slips and touches the stop switch 5B because of sweat and/or vibration, accidentally stopping the blower against the operator's intension.

On the other hand, in the case where the stop switch 5B is of the type which is slid backward of the grip 5 to stop the blower, there will be no such accidental stop but the operator needs to keep pressing forward the stop switch with the thumb even when it is slippery because of sweat and/or vibration. If the stop switch is provided with surface irregularities for preventing slippage, the operator may suffer pain on the thumb TH because of the force of reaction from the protruded parts of the irregularities, and may find it hard to continue the operation.

Generally, when air is blown out from the opening 6A of the blower 1, the end pipe 6 lifts up because of the force of reaction of the blown air hitting the ground. The blower 1 has its center of gravity near the output shaft of the engine, but the grip 5 is located apart from the engine output shaft, to which the impeller is coupled. As the supporting point does not match the center of the gravity, a moment is created at the gripping position, making it hard to maintain the end pipe constantly in one position.

In order to keep the end pipe 6 directed to a certain position on the ground, the thumb on the grip plays a great role, because of which a large load is applied to the thumb, causing the operator's fatigue.

### SUMMARY OF THE INVENTION

Based on the foregoing, it is an object of the present invention to overcome the problems associated with the conventional technique and to provide a handheld blower having a structure which can prevent accidental stop of the blower during use and enable the operator to keep orienting an end pipe thereof to a desired direction while mitigating the load exerted on an operator's thumb on the grip.

According to a first aspect of the present invention, provided is a handheld blower including a power source, an impeller provided coaxially with an output shaft of the power source, a casing accommodating the impeller, and an end pipe having an opening at one end and coupled at the base end to the upper half of the casing such as to extend in a tangential direction of the impeller. The handheld blower comprises a grip which is grasped by an operator's fingers to support the blower in a suspended manner, a stop switch provided on an extension line of the widthwise center line of the grip, and a thumb rest extending to a side of the grip near from the stop switch for receiving the operator's thumb.

In the handheld blower according to a second aspect thereof, the thumb rest may be extended from the grip 20 mm or more.

In the handheld blower according to a third aspect thereof, the thumb rest may have a surface on which the thumb rests, which surface is positioned forward of the center of the impeller when the blower is placed on the ground, and inclined at an angle within an angle range which is from a reference line parallel to the ground to a plane perpendicular to the blowing direction.

In the handheld blower according to a fourth aspect thereof, the surface of the thumb rest may be inclined at an angle such that the surface is approximately parallel to the ground during a normal operation in which the grip is held by the operator's fingers in a suspended manner.

The handheld blower according to a fifth aspect thereof, may further comprise switch guards on the grip at both sides of the stop switch such as to stand higher than the stop switch.

In the handheld blower according to a sixth aspect thereof, the thumb rest may be provided on both sides of the stop switch.

According to the first and the second aspects, it is unlikely that the thumb will touch the stop switch when it slips, because the thumb rest is extended to a side from near the stop switch which is positioned on the extension line of the widthwise center line of the grip. An accidental stop of the blower during the operation is thus prevented.

Moreover, according to the second aspect the thumb rest provides enough space for the thumb to rest and prevents local concentration of load on the thumb unlike the case where the thumb rest size is too small. The operator can therefore maintain a good grip, experiencing less fatigue.

Furthermore, according to the third and the fourth aspects, it is easier to hold down the blower to prevent its end pipe from lifting up from the ground, because the thumb rest surface is positioned and inclined within a predetermined angle range as discussed above, and because it is approximately parallel to the ground during a normal use. In particular, according to the fourth aspect, the operator can stably maintain the position of the thumb without any discomfort during the blowing operation, because the surface is positioned forward of the center of the impeller and approximately parallel to the ground when the grip is held by the operator's fingers in a suspended manner.

According to the fifth aspect, the switch guards which stand on the both sides of the stop switch higher than the switch prevent the thumb from touching the switch even when it moves sideways accidentally. An accidental pause of operation is thus prevented. The switch guards require the operator to move the thumb over the switch guards when necessary and makes the operator to be clearly aware that she/he wishes to operate the stop switch, and so it is prevented that the blower is abruptly stopped against the operator's intention.

According to the sixth aspect, the thumb rests, which are provided on both sides of the stop switch, ensure that the end pipe is properly oriented during the operation irrespective of whether or not the operator is left-handed or right-handed.

### BRIEF DESCRIPTION OF THE DRAWINGS

These and other objects and advantages of the present invention will become understood from the following description with reference to the accompanying drawings, wherein:

FIG. 1 is a plan view of a handheld blower including a thumb rest surface according to one embodiment of the present invention;

FIG. 2 is a side view of the handheld blower of FIG. 1;

FIG. 3 is a side view for explaining how the thumb rest surface is formed on the handheld blower of FIG. 2;

FIG. 4 illustrates the grip of the handheld blower of FIG. 2 enlarged to a greater scale;

FIG. 5 shows the handheld blower of FIG. 2 in one usage example; and

FIG. 6 is an enlarged external view for explaining the structure of a grip of a conventional handheld blower.

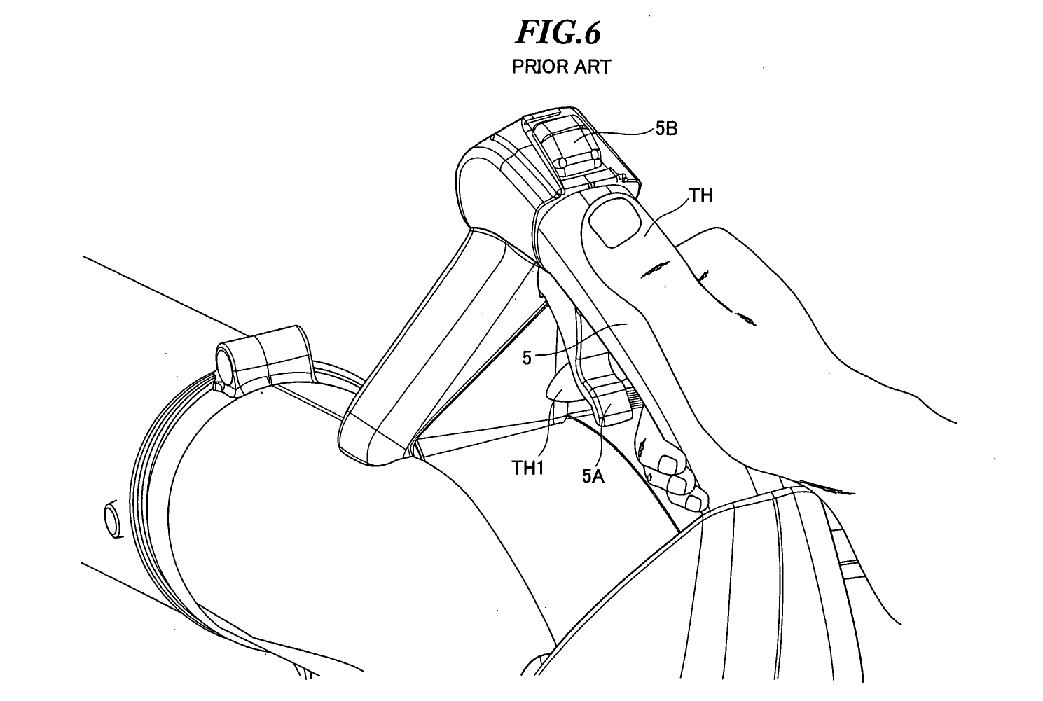

### DETAILED DESCRIPTION OF THE PREFERRED EMBODIMENTS

Preferred embodiments of the present invention will be hereinafter described with reference to the accompanying drawings

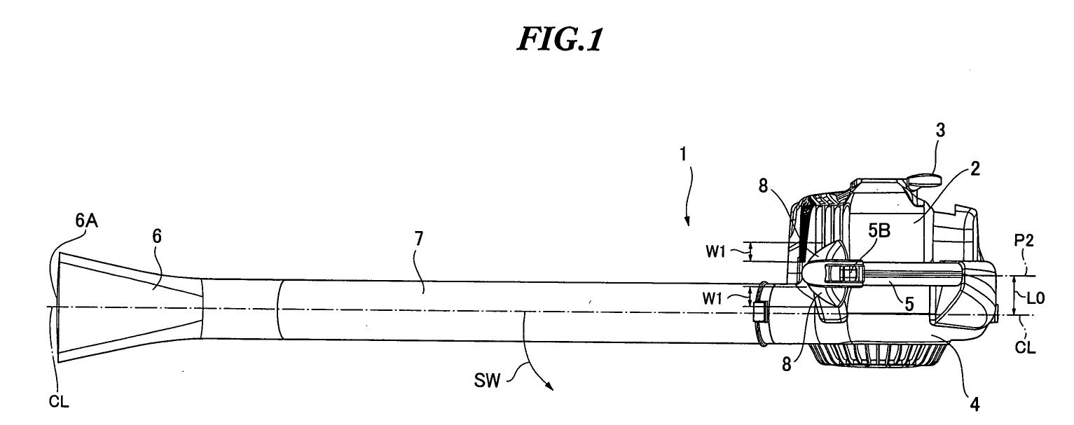

FIG. 1 is a plan view of a handheld blower 1 according to one embodiment of the present invention.

The blower 1 includes an engine (not shown) as the power source accommodated in an engine cover 2. The engine is started by pulling a recoil starter knob 3.

A casing 4 accommodates an impeller (not shown) which is attached to the output shaft of the engine. The engine cover 2 and the casing 4 together form a drive unit of the blower 1.

The engine cover 2 and the casing 4 are both molded parts which are produced using a split mold. A grip 5 is provided on top of the engine cover 2 and the casing 4. The structure of the grip 5 will be described in more detail later.

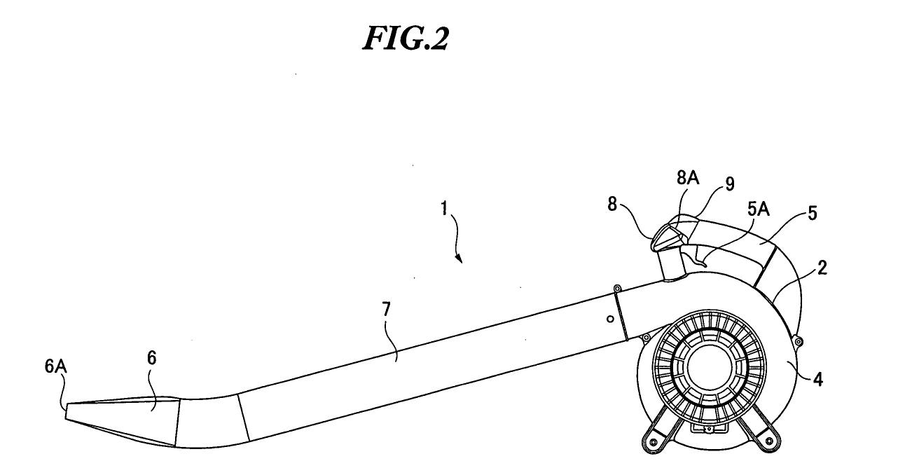

As shown in FIG. 2, the casing 4 accommodating the impeller inside communicates with an end pipe 6, which has an opening 6A at the end, through a coupling pipe 7.

The coupling pipe 7 is connected to the end pipe 6 at the distal end and coupled to the upper half side of the casing 4 at the other end such that the coupling pipe 7 extends in a tangential direction of the impeller. Thus the end pipe 6 is positioned along the extension of this tangential line.

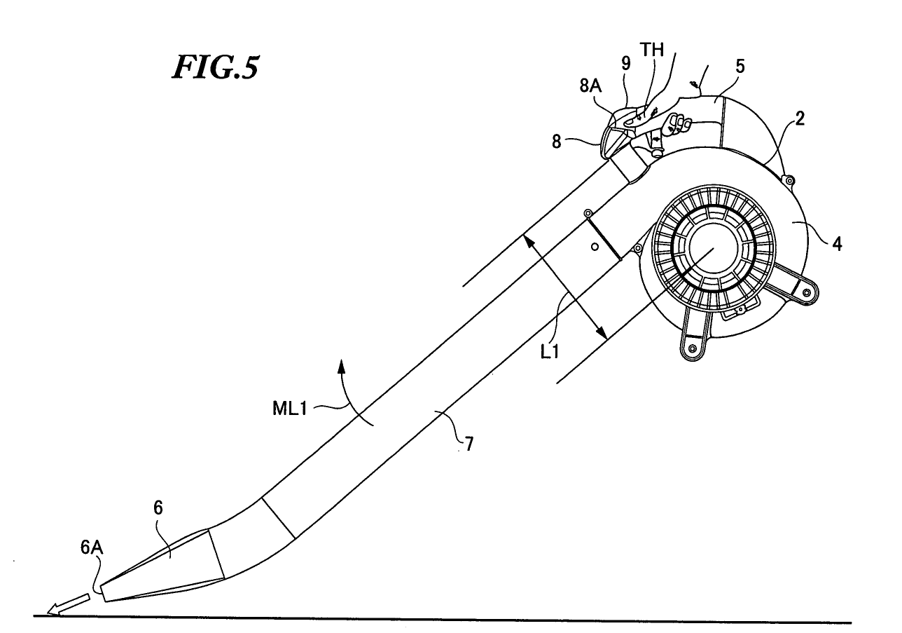

As shown in FIGS. 2 and 5, the grip 5 which is provided on the top of the engine cover 2 and the casing 4 defines an arch with a space which allows the operator's fingers other than the thumb to pass through.

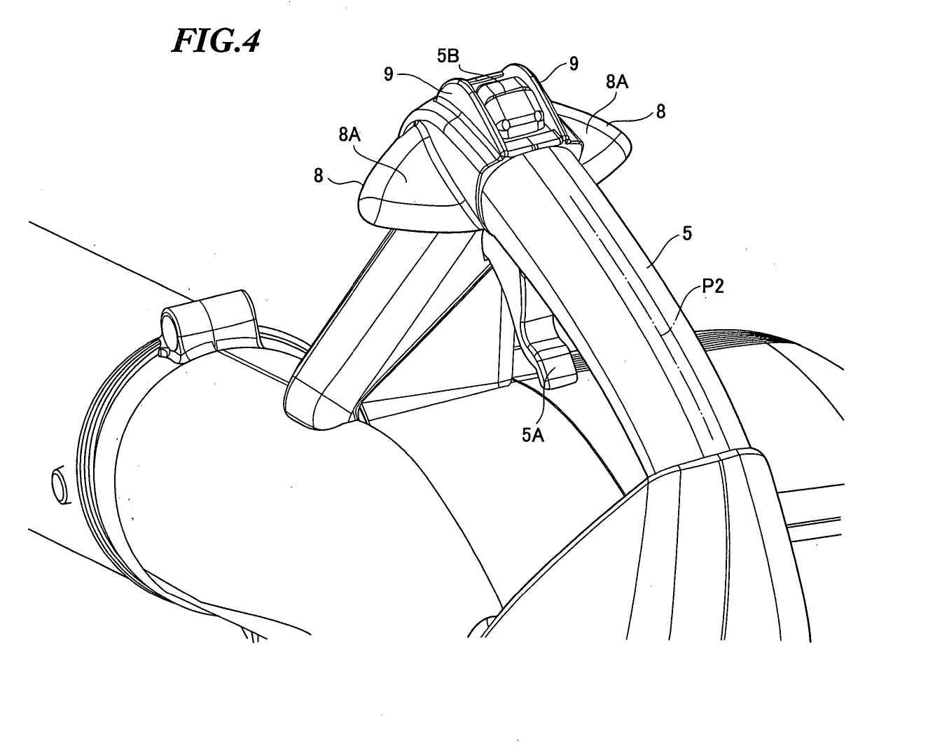

The grip 5 includes a throttle lever 5A on the underside facing the space, and a stop switch denoted at 5B in FIGS. 1 and 4 on the upper side.

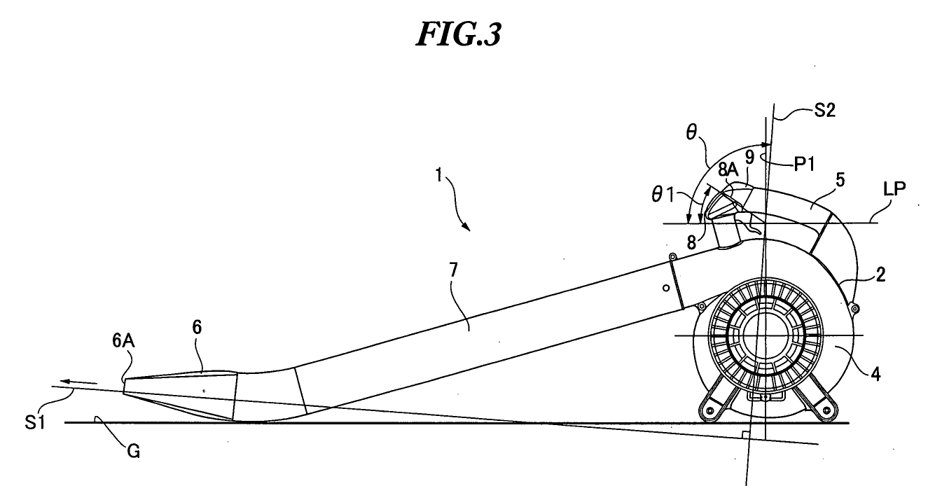

The stop switch 5B is positioned farther to the front (toward the end pipe 6) than a line P1 passing through the center of the impeller (see FIG. 3). In this embodiment, the stop switch 5B is positioned on a distal end side of the grip 5 along an extension line of a widthwise center line P2 (see FIGS. 1 and 4) of the grip 5.

As shown in FIG. 4, thumb rests 8 extend to the sides of the grip 5 from near the stop switch 5B.

The thumb rests 8 are positioned such that the operator can rest his/her thumb TH thereon as shown in FIG. 5. The thumb rests 8 are extended to both sides of the widthwise center line P2 of the grip 5 as shown in FIGS. 1 and 4. The extending width W1 (FIG. 1) from the side face of the grip 5 is 20 mm or more.

The thumb rest 8 is substantially a triangular pyramid. When viewed from the side, as shown in FIG. 3, the bottom side of the triangle faces the ground G, and when viewed from above, as shown in FIGS. 1 and 4, the bottom side of the triangle coincides with the base part of the thumb rest on the grip 5. One diagonal of the triangle viewed from the side defines the thumb rest surface 8A. This shape enables the cantilevered thumb rest 8 to have good rigidity properties, in particular flexural rigidity, with respect to the pressure applied on the thumb TH on the thumb rest surface 8A.

The thumb rest surface 8A is formed to satisfy the following conditions as shown in FIGS. 2 and 3:

Referring to FIG. 3, when the blower 1 is placed on the ground G, the thumb rest surface 8A is inclined at an angle θ1 which is set within an angle θ which is from a reference line LP parallel to the ground G to a plane S2 which is perpendicular to the blowing direction denoted at S1.

In this embodiment, the angle θ1 of the surface 8A is set 30° so that the surface 8A is approximately parallel to the ground G when the opening 6A at the end of the end pipe 6 is oriented toward the ground during the blowing operation of the blower 1 as shown in FIG. 5.

With the thumb rest surface 8A being inclined at the above angle, the moment ML1, which is generated because of the distance denoted at L1 in FIG. 5 between the center of gravity of the engine near its output shaft and the grip 5, is well counterbalanced. As a result, the operator can readily keep down the end pipe 6 which tends to lift up because of the moment ML1 during the blowing operation.

While the thumb rest 8 is provided on both sides of the stop switch 5B in this embodiment, it can be provided only on one side. Also, the thumb rest 8 of the present invention can be attached to conventional type grips.

The thumb rest surface 8A can either be a smooth or irregular surface, or include a high frictional coefficient material layer to prevent slippage.

Furthermore, because the thumb rest 8 is extended sideways from the side face of the grip 5, the sway (denoted at SW in FIG. 1) of the end pipe 6 in the horizontal direction, which is caused because of the distance L0 between the center line CL of the opening 6A and the widthwise center line P2 of the grip 5, is well suppressed. As a result, the operator can stably maintain the end pipe 6 oriented to a desired direction during the blowing operation. The sway SW will be suppressed more effectively if the thumb is placed on the thumb rest 8 on the side of the direction of the sway.

As shown in FIGS. 2 to 4, on the grip 5 near the stop switch where the thumb rests 8 are positioned, switch guards 9 are provided on the both sides of the stop switch 5B such as to stand higher than the stop switch 5B.

The switch guards 9 are positioned between the thumb rests 8 and the stop switch 5B so as to prevent the operator from touching the stop switch 5B inadvertently with the thumb on the surface 8A. Since the operator needs to move the thumb over the switch guards 9 to operate the stop switch 5B, it is unlikely that the blowing operation is stopped against the operator's intention because of the thumb accidentally touching the stop switch 5B.

While there has been described what are at present considered to be preferred embodiments of the present invention, it will be understood that various modifications may be made thereto, and it is intended that the appended claims cover all such modifications as fall within the true spirit and scope of the invention.

1. A handheld blower having a power source, an impeller provided coaxially with an output shaft of the power source, a casing accommodating the impeller, and an end pipe having an opening at one end and coupled at a base end thereof to an upper half of the casing such as to extend in a tangential direction of the impeller, the handheld blower comprising:
a grip grasped by an operator's fingers to support the blower in a suspended manner;
a stop switch provided on an extension line of a widthwise center line of the grip; and
a thumb rest extending to a side of the grip near from the stop switch for receiving the operator's thumb.

2. The handheld blower according to claim 1, wherein
the thumb rest is extended from the grip 20 mm or more.

3. The handheld blower according to claim 1, wherein
the thumb rest has a surface on which the thumb rests, which surface is positioned forward of the center of the impeller when the blower is placed on the ground, and inclined at an angle within an angle range which is from a reference line parallel to the ground to a plane perpendicular to the blowing direction.

4. The handheld blower according to claim 3, wherein
the surface of the thumb rest is inclined at an angle such that the surface is approximately parallel to the ground during a normal operation in which the grip is held by the operator's fingers in a suspended manner.

5. The handheld blower according to claim 1, further comprising switch guards on the grip at both sides of the stop switch such as to stand higher than the stop switch.

6. The handheld blower according to claim 1, wherein
the thumb rest may be provided on both sides of the stop switch.
